(19) United States
(12) Patent Application Publication
(10) Pub. No.: US 2003/0234714 A1
(43) Pub. Date: Dec. 25, 2003

(54) Winding device and method for manufacturing the same

(75) Inventors: Yiyoung Sun, Beverly, MA (US); Yoshiaki Takami, Malden, MA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Matsushita Electric Works, R&D Laboratory, Inc., Woburn, MA

(21) Appl. No.: 10/175,782

(22) Filed: Jun. 21, 2002

(51) Int. Cl. H01F 27/28

(52) U.S. Cl. 336/182

(57) ABSTRACT

A winding device includes a core, a wire winding provided in the core, and a heat conductive material. The heat conductive material is provided around an outer surface of the wire winding to contact the wire winding and the core via the heat conductive material.

### BACKGROUND OF THE INVENTION

1. Field of the Invention

The present invention relates to a winding device, for example, a transformer, an inductor and the like. The present invention further relates to a method for manufacturing the winding device.

2. Discussion of the Background

U.S. Pat. No. 4,845,606 discloses a matrix transformer that includes a plurality of independent magnetic elements interwired as a transformer. The contents of this patent are incorporated herein by reference in their entirety. This transformer exhibits very low leakage inductance at high frequency applications. U.S. Pat. No. 5,012,125 discloses a shielded transformer that utilizes a shielded electrical wire. The contents of this patent are incorporated herein by reference in their entirety. This transformer exhibits very low parasitic capacitance and high common mode rejection ratio. U.S. Pat. No. 5,124,681 discloses a transformer whose wire winding is wound in a tilted arrangement. The contents of this patent are incorporated herein by reference in their entirety. This transformer has very high withstanding voltage and it is intended for very high voltage applications.

### SUMMARY OF THE INVENTION

According to one aspect of the present invention, a winding device includes a core, a wire winding provided in the core, and a heat conductive material. The heat conductive material is provided around the outer surface of the wire winding to contact the wire winding and the core via the heat conductive material.

According to another aspect of the present invention, a method for manufacturing a winding device includes winding at least one wire to form a wire winding and providing a heat conductive material around an outer surface of the wire winding. The wire winding with the beat conductive material is squeezed into a space formed in a core to contact the wire winding and the core via the heat conductive material.

According to yet another aspect of the present invention, a ballast circuit includes a winding device. The winding device includes a core, a wire winding provided in the core, and a heat conductive material. The heat conductive material is provided around the outer surface of the wire winding to contact the wire winding and the core via the heat conductive material.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a circuit diagram of a high intensity discharge (HID) lamp ballast circuit that includes a transformer according to an embodiment of the present invention;

FIG. 2 is a perspective view of the transformer according to the embodiment of the present invention;

FIG. 3 is a cross-sectional view of the transformer according to the embodiment of the present invention; and

FIG. 4 is an explanatory illustration for explaining a method for manufacturing the transformer according to the embodiment of the present invention.

### DESCRIPTION OF THE EMBODIMENTS

The embodiments will now be described with reference to the accompanying drawings, wherein like reference numerals designate corresponding or identical elements throughout the various drawings.

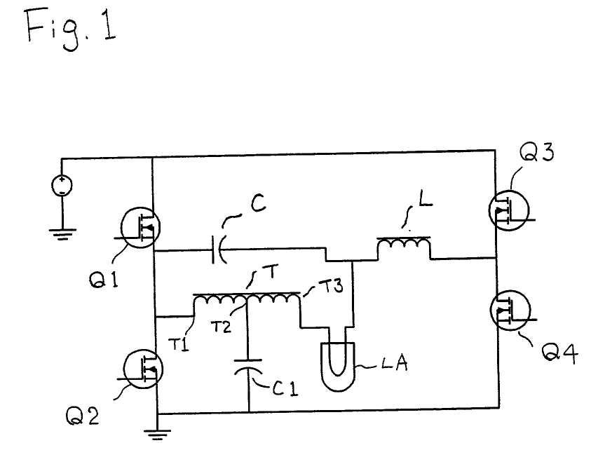

FIG. 1 is a high intensity discharge (HID) lamp ballast circuit diagram that includes a transformer (T) according to an embodiment of the present invention. Referring to FIG. 1, control switches (Q1 and Q2) are connected to an electric power source in series. Similar, control switches (Q3 and Q4) are connected to the electric power source in series. The control switches (Q1 and Q2) and the control switches (Q3 and Q4) are provided in parallel. A buck filter capacitor (C) and a buck filter inductor (L) are connected in series to connect a point between the control switches (Q1 and Q2) and a point between the control switches (Q3 and Q4). The transformer (T) and the buck filter capacitor (C) are provided in parallel. The transformer (T) has three terminals (T1, T2 and T3). An ignition capacitor (C1) is provided between the terminal (T2) of the transformer (T) and a point between the control switches (Q2 and Q4). During an ignition phase, which is in the order of seconds, the transformer (T) and the ignition capacitor (C1) form a resonant network driven by the control switches (Q1 and Q2). A high voltage of about 4 (KV) appears between the terminals (T1 and T3) of the transformer (T). Since the duration of the ignition phase is very short, any loss in the wire winding or in the core of the transformer (T) can be neglected in designing the transformer (T). In a normal operation after starting, the control switches (Q1 and Q4) form one branch of the buck converter with the control switch (Q4) switching in high frequency and the control switch (Q1) staying on. The control switches (Q2 and Q3) form the other branch of the buck converter with the control switch (Q3) switching in high frequency and the control switch (Q2) staying on. These two branches alternatively switch, causing a low frequency square wave current to flow through the lamp load (LA). In half of a low frequency cycle, current flowing through the inductor (L) is the combination of AC and DC current. The AC part of the inductor current flows through the buck filter capacitor (C). The DC part of the inductor current flows through the transformer (T), which is also the lamp current. In reality, the filter capacitor (C) cannot filter out all the AC components. There is a small amount of ripple superimposed on the DC current. Since the ripple is very small, the transformer core loss can be considered substantially zero and the wire winding loss is purely a DC resistance loss.

For example, a 100W metal halide lamp ballast delivers current of 1.1 A and less than 10% high frequency peak-peak ripple, or 55 mApk maximum, to the lamp. The inductance of the transformer (T) measured between the terminals (T1 and T3) is 3 mH wound with 220 turns. The operating frequency is 60 (KHz). EER28 core is used with effective core area of 82.1 mm. The AC peak flux, Bac_pk is expressed by the following equation:

$$Bac\_pk = \frac{3 mH * 55 mApk}{220 t * 82.1 mm} = 0.0091 Tesla$$

The value of the Bac_pk is very low and the core loss is virtually zero. The only loss in the application is the wire winding loss. Accordingly, the temperature of the wire winding is higher than that of the core.

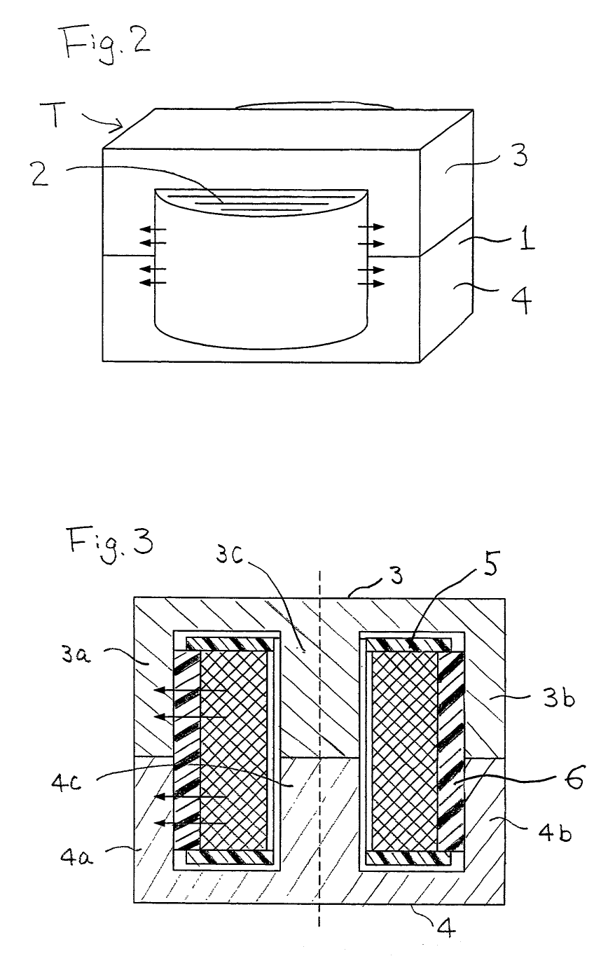

FIGS. 2 and 3 illustrate the transformer (T). Referring to FIGS. 2 and 3, the transformer (T) includes a core 1 and a wire winding 2. The core 1 is made of ferrite material and has an upper half core 3 and a lower half core 4. Each of the upper half core 3 and the lower half core 4 has first and second end projections (3a and 3b, and 4a and 4b) and a center projection (3c and 4c) provided at a center between the first and second end projections (3a and 3b, and 4a and 4b). The wire winding 2 is wound around the center projections (3c and 4c).

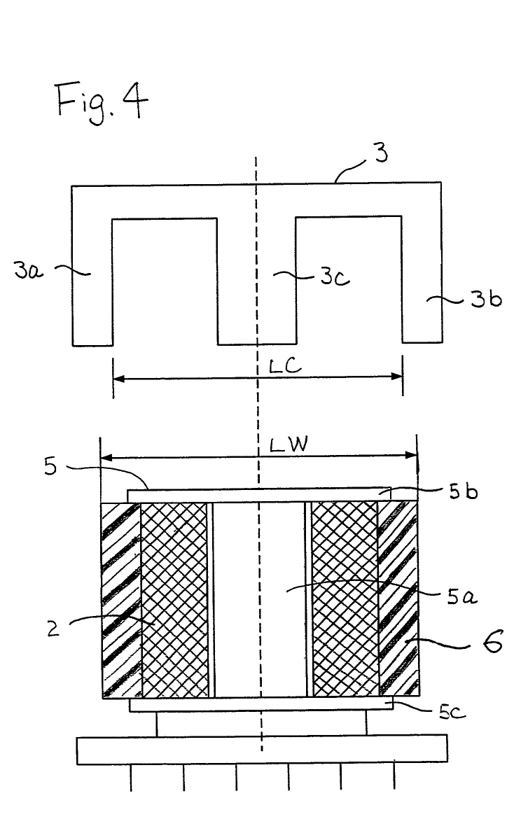

Referring to FIG. 4, the bobbin 5 has a cylindrical portion (5a) and flanges (5b and 5c) at both ends of the cylindrical portion (5a), respectively. A wire is wound around the cylindrical portion (5a) of the bobbin 5 between the flanges (5b and 5c) to form the wire winding 2. A heat conductive material, for example, an outer layer tape 6 is wound around the outer circumferential surface of the wire winding 2. The heat conductive material has, for example, better thermal conductivity than still air which is a thermal insulator. The outer layer tape 6 is, for example, a fiber tape or any fiber/cloth sheet that absorbs filling material such as varnish material. The outer layer tape 6 is, for example, porous. At least one wire winding length (LW) is slightly larger than a core length (LC) between the first and second end projections (3a and 3b, or 4a and 4b). Namely, the size of the wire winding 2 with the outer layer tape 6 is larger than the size of the space formed in the core 1. Then, the upper half core 3 and a lower half core 4 are connected such that the center projections (3c and 4c) are inserted into the cylindrical portion (5a) of the bobbin 5 (FIG. 3). The wire winding 2 with the outer layer tape 6 is squeezed into the grooves (space) formed between the center projections (3c or 4c) and the first and second end projections (3a and 3b, or 4a and 4b) as the outer layer tape 6 deforms. Therefore, the wire winding 2 securely contacts the inside of the core 1 via the outer layer tape 6. Accordingly, good thermal conduction from the wire winding 2 to the core 1 may be obtained.

Although a portion of the bobbin 5 around which the wire winding 2 is wound has a cylindrical shape (cylindrical portion (5a)) in the present embodiment, the portion of the bobbin 5 may have other shapes. For example, the cross-section of the portion of the bobbin 5 taken along a line substantially parallel to the flanges (5b and 5c) may be rectangular, elliptical and the like.

Then, the transformer (T) is impregnated with filing material, for example, varnish material so that the wire winding 2, the outer layer tape 6, and the core 1 securely contact with each other to be thermally connected through conduction. Namely, the air gaps between the wire winding 2 and the core 1 and the air gaps between layers of the outer layer tape 6 are minimized. Preferably, to obtain better thermal conduction from the wire winding 2 to the core 1, all air gaps are removed within layers of the outer layer tape 6. In the present embodiment, the air gaps between the outer layer tape 6 are minimized.

In the present embodiment of the present invention, the outer layer tape 6 is provided between the outer circumferential surface of the wire winding 2 and the core 1 to securely contact the wire winding 2 and the core 1 via the outer layer tape 6. Accordingly, the heat generated in the wire winding 2 is conducted by the outer layer tape 6 to the core 1 to be dissipated through conduction. Therefore, the heat conductivity from the wire winding 2 to the core 1 may improve.

The outer layer tape 6 is a fiber tape, or a fiber tape with film backing for ease of usage and strength. For example, the outer layer tape 6 is a combination tape with thickness of 0.5 mm including polyester film with thickness of 0.05 mm and polyester nonwoven fabric with thickness of 0.35 mm. The fiber tape is impregnated with filling material such as varnish materials. Accordingly, any air gaps formed in the fiber tape are removed. Thus, a solid material path for heat conduction is established from the wire winding 2 to the core 1. Solid materials, such as varnish, have much better thermal conductivity than still air which is a thermal insulator. Although in the present embodiment, vanish materials are used to fill the air gaps, other materials may be used.

A 100W HID ballast system including a transformer according to the present embodiment of the present invention was produced. The ballast system was running at full power and sat on a wooden table. The temperature was then read after thermal equilibrium. In this system, the temperature on the wire winding decreased 5° C. from 83° C. to 78° C. at 30° C. ambient temperature.

In order to further reduce the thermal resistance from the transformer assembly to the surface of the ballast enclosure, potting compound may be added to contact the bottom of the core.

An entire ballast system may be encapsulated with potting compound. In this case, however, the cost increases. In the present embodiment according to the present invention, the outer layer tape 6 is wound around only the outer circumferential surface of the wire winding 2. Accordingly, the cost of the transformer may reduce comparing to the case where the entire ballast system is encapsulated with potting compound.

Although in the present embodiment of the present invention, a transformer is explained as a winding device, the present invention may apply to other similar constructions such as an inductor.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by letters Patent of the U.S is:

1. A winding device comprising:
a core;
a wire winding provided in the core and having an outer surface; and
a heat conductive material provided around the outer surface of the wire winding to contact the wire winding and the core via the heat conductive material.

2. A winding device according to claim 1, wherein the heat conductive material comprises a tape which is wound around the outer surface of the wire winding.

3. A winding device according to claim 2, wherein the tape is made of fiber.

4. A winding device according to claim 1, wherein the heat conductive material is impregnated with filling material.

5. A winding device according to claim 4, wherein the filling material is vanish material.

6. A winding device according to claim 1, wherein the heat conductive material is porous.

7. A winding device according to claim 1, wherein the core has a space into which the wire winding is inserted, and wherein a size of the space is smaller than a size of the wire winding with the heat conductive material such that the wire winding with the heat conductive material is squeezed into the space of the core.

8. A winding device according to claim 1, wherein an assembly of the core, the wire winding and the heat conductive material is impregnated with filling material.

9. A winding device according to claim 8, wherein the filling material is vanish material.

10. A winding device according to claim 1, further comprising:
a bobbin around which the wire winding is wound.

11. A method for manufacturing a winding device, comprising:
winding at least one wire to form a wire winding;
providing a heat conductive material around an outer surface of the wire winding; and
squeezing the wire winding with the heat conductive material into a space formed in a core to contact the wire winding and the core via the heat conductive material.

12. A method according to claim 11, wherein the providing step includes winding a tape which is the heat conductive material around the outer surface of the wire winding comprises a tape which is wound.

13. A method according to claim 12, wherein the tape is made of fiber.

14. A method according to claim 11, further comprising:
impregnating the heat conductive material with filling material.

15. A method according to claim 14, wherein the filling material is vanish material.

16. A method according to claim 11, wherein the heat conductive material is porous.

17. A method according to claim 11, wherein a size of the space of the core is smaller than a size of the wire winding with the heat conductive material such that the wire winding with the heat conductive material is squeezed into the space of the core.

18. A method according to claim 11, further comprising:
impregnating an assembly of the core, the wire winding and the heat conductive material with filling material.

19. A method according to claim 18, wherein the filling material is vanish material.

20. A winding device according to claim 2, wherein the tape includes at least two layers.

21. A method according to claim 12, wherein the tape includes at least two layers.

22. A ballast circuit comprising:
a winding device comprising:
a core;
a wire winding provided in the core and having an outer surface; and a heat conductive material provided around the outer surface of the wire winding to contact the wire winding and the core via the heat conductive material.

23. A winding device according to claim 1, wherein the heat conductive material has better thermal conductivity than that of air.

24. A method according to claim 11, wherein the heat conductive material has better thermal conductivity than that of air.
